(19) United States
(12) Patent Application Publication
(10) Pub. No.: US 2007/0160951 A1
(43) Pub. Date: Jul. 12, 2007

(54) PROCESS AND APPARATUS FOR THE TREATMENT OF MEDICAL WATER

(75) Inventors: Roberto Bolognini, Bologna (IT); Daniele Garelli, Bologna (IT)

Correspondence Address: EGBERT LAW OFFICES, 412 MAIN STREET, 7TH FLOOR, HOUSTON, TX, 77002, US

(73) Assignee: ECOPLUS, S.R.L., San Lazzaro di Savena (IT)

(21) Appl. No.: 11/621,514

(22) Filed: Jan. 9, 2007

(30) Foreign Application Priority Data
Jan. 11, 2006 (IT) BO2006A000013

(51) Int. Cl. A61C 17/02

(52) U.S. Cl. 433/80

(57) ABSTRACT

The invention relates to a process, and system for the implementation thereof, for achieving a dual sterilization of the water supplied to a dental unit, so as to eliminate both the waterborne bacteria and the bacterial contamination which forms in the water lines in proximity to the connection points of dynamic instruments.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a procedure, and system for the implementation thereof, which renders main line drinking water suitable also for medical use.

2. Description of Related Art Including Information Disclosed Under 37 CFR 1.97 and 37 CFR 1.98.

With reference in particular to dental surgeries, various apparatuses include dental units, heat disinfectors, and scrub sinks, normally connected to a main water supply. Sterilization and purification of the water in circulation is necessarily required in those water systems. Without a supply of distilled water, it is affirmed that none of the current systems is able to furnish the guarantee of total hygiene achieved by the present invention. The present invention not only ensures the elimination of inorganic impurities such as metals and dissolved salts, but also provides a dual, direct action against the organic micro-organisms harbored in the main water supply used to supply dental instruments and against bacteria and viruses originating from the oral cavity of patients undergoing treatment. The latter are, in fact, responsible for the contamination of the terminal sections of dental instrument water lines, and consequent contamination of subsequently treated patients, though the water in circulation may itself be determined to be bacteriologically pure.

It is well known that, due to retraction or capillary action, biological fluids from the oral cavity contribute to the formation of so-called “biofilms”, which are none other than a bacterial community entrapped within a polysaccharide matrix that deposits on the walls of instrument water lines and causes, according to reliable estimates, 65% of hospital infections.

### BRIEF SUMMARY OF THE INVENTION

The present invention thus aims primarily to eliminate both the first source of contamination, by means of a reverse osmosis process that renders main line water pure and safe, and the second source, by means of a chlorine dioxide based disinfection process, specifically conceived for sterilization of the environment which may have been contaminated due to spray retraction phenomena.

These and other characteristics will now become more apparent upon reading the description of a simple embodiment of the invention, which is given for purely illustrative purposes and does not restrict the scope of this patent.

### BRIEF DESCRIPTION OF THE SEVERAL VIEWS OF THE DRAWINGS

FIG. 1 illustrates a schematic view of a preferred embodiment of a dental unit water supply system.

### DETAILED DESCRIPTION OF THE INVENTION

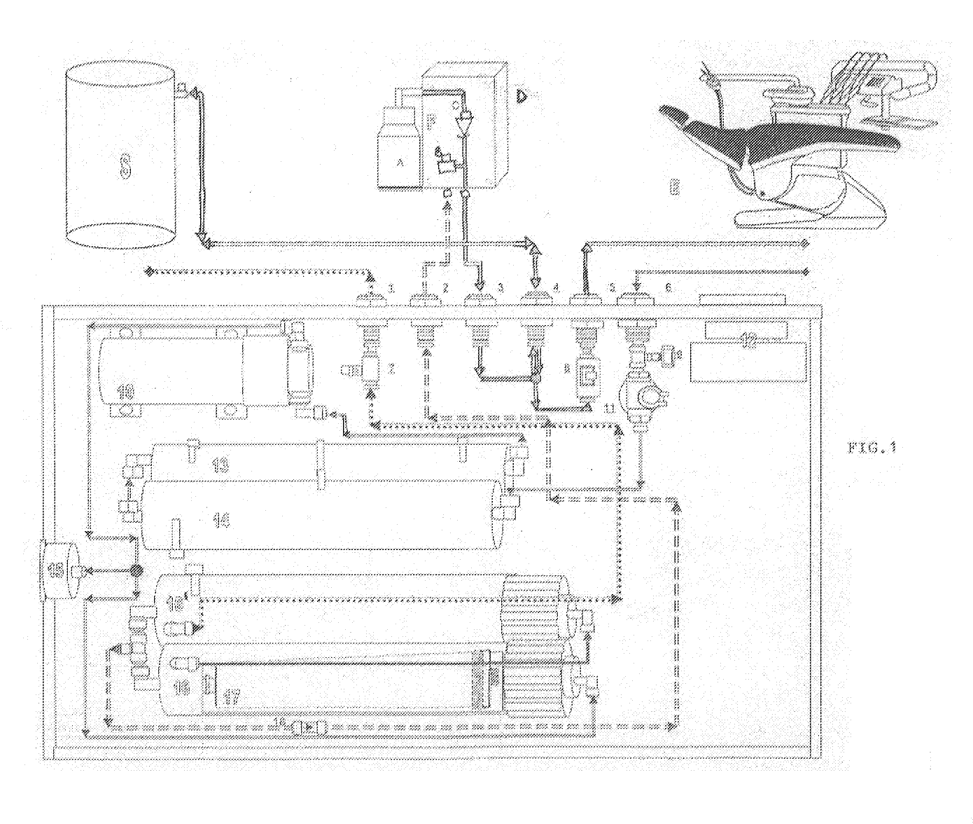

With reference to FIG. 1, there is the main line water outlet 6, a minimum pressure switch 9, a feed solenoid valve 11, a sediment pre-filter 14, a carbon block pre-filter 13, a delivery pump 10, and a pressure gauge 15 for the water. The vessel 16 contains the first osmotic membrane 17, and the second vessel 16′ contains the second membrane connected in series. Second membrane, jointly with the first membrane, induces the separation of the concentrate, which is channeled to the drain 1 through the flow restrictor 7, from the permeate, which after crossing the check valve 18, arrives at the water unit F through the nozzle 2.

The umbilical cable D connects the unit (F) to the electronic control. A flow gauge B for the permeate, and an injection pump C, that draws chlorine dioxide from the container A, introduces the right amount thereof into the permeate to form the treated water. The nozzle 3 discharges the treated water from the unit (F) by the inlet and outlet nozzles 4 of the tank S. There is a maximum pressure switch 8, and the outlet nozzle 5 for the treated water is ready to be supplied, in the specific case illustrated, to the dental unit indicated as E, and the electric controller 12.

In practice, the construction details, dimensions, materials, shape and other aspects of the invention may vary without departing from the scope of the present industrial patent. In fact, the invention thus conceived lends itself to numerous adaptations and variants, all falling within the realm of the inventive concept. In addition, all the elements may be replaced by other technically equivalent ones.

1. Process for treatment of medical water said process comprising the steps of:
performing a reverse osmosis treatment on water from an outside source; and
performing a cold sterilization treatment with, chlorine dioxide, before arriving at a point of distribution.

2. Apparatus for treatment of medical water, serving to implement the process, of claim 1, said apparatus comprising:
a reverse osmosis unit comprising a minimum pressure switch, feed solenoid valve, sediment pre-filter, carbon block pre-filter, delivery pump, water pressure gauge, two series-connected membrane vessel assemblies incorporating osmotic membranes, a check valve for permeate and a flow restrictor for concentrate;
means for treating the permeate, comprising a container of chlorine dioxide or another suitable sterility, a flow gauge, an injection pump and cable for connection to an electronic control; and
a storage tank for the treated water and a maximum pressure switch controlling the supply to the user.

3. Apparatus for the treatment of medical water, according to claim 2, serving one or more dental units or other medical equipment and fixtures and being incorporated into the dental unit or equipment.

4. Process for the treatment of medical water, according to claim 1, further comprising:
supplying treated water to applications of an industrial nature relating to products, washing of foodstuffs prior to sale, or relating to product containers, washing of bottles prior to bottling.
